(19) United States
(12) Patent Application Publication
(10) Pub. No.: US 2025/0209605 A1
(43) Pub. Date: Jun. 26, 2025

(54) IMPROVEMENTS IN OR RELATING TO INSPECTION AND QUALITY CONTROL

(71) Applicant: Cheyney Design & Development Ltd., Litlington, Royston Hertfordshire (GB)

(72) Inventor: Richard Parmee, Litlington, Royston Hertfordshire (GB)

(73) Assignee: Cheyney Design & Development Ltd., Litlington, Royston Hertfordshire (GB)

(21) Appl. No.: 18/847,295

(22) PCT Filed: Mar. 17, 2023
(86) PCT No.: PCT/GB2023/050645

§ 371 Date: Sep. 16, 2024

(30) Foreign Application Priority Data
Mar. 17, 2022 (GB) 2203758.4

(51) Int. Cl. G06T 7/00

(52) U.S. Cl. CPC G06T 7/0006; G06T 2207/30108

(57) ABSTRACT

A method for inspection and quality control for identifying, and automatically rejecting, non-conformant products. The method including: scanning a product to be tested to provide scanning data of the product; analysing the scanning data in a first inspection path including a rule-based analysis of the scanning data to determine conformity or non-conformity of the product; analysing the scanning data in a second inspection path including a machine learning analysis of the scanning data to determine conformity or non-conformity of the product; analysing relative performance of the first inspection path and second inspection path to determine which provides a greater probability of correctly identifying conformity or non-conformity of the product; and controlling automatic rejection of non-conformant products depending upon which inspection path provides the greater probability of correctly identifying a non-conformant product.

### CROSS-REFERENCE TO RELATED APPLICATIONS

This application is a U.S. National Phase Application of International Application Serial No.: PCT/GB2023/050645 filed Mar. 17, 2023, which claims priority to Great Britian Application Serial No. 2203758.4, filed Mar. 17, 2022, the content of such applications being incorporated by reference herein in their entirety.

### FIELD OF THE INVENTION

The present invention relates to a method for inspection and quality control. In particular, the present invention relates to a method for inspection and quality control for identifying, and automatically rejecting, non-conformant products, and an associated apparatus.

### BACKGROUND OF THE INVENTION

Historically, algorithms have been used successfully over many years in inspection and quality control systems; however, this requires the setting of tolerances or limits on the results of the analysis. In other words the analysis applies a series of rules—which is why it is often termed a ‘rule-based’ approach. An example of an improved algorithm is a Highly Adaptive Algorithm (HAA), and this term will be used from hereon. Products do change during a production cycle, and HAA (or a less advanced algorithm) is limited in its ability to respond to those changes. Further, HAA cannot adapt to changing products, or product specifications without one adapting the corresponding rules. Further, it is incapable of learning.

Machine Learning (ML) has existed in various incarnations since the late 1980's, at least in the form of ANNs (artificial neural networks). However, it has been only recently that resources have evolved to provide a viable implementation. Those skilled in the art will know that ML is considered to come under the overall umbrella of artificial intelligence, in which computer algorithms may be automatically improved over time and experience. ML is already widely used in e-mail filtering, speech recognition, and other fields where conventional methods struggle to perform adequately, if at all, or do not adapt well to changing circumstances. ML over time builds a model, initially from sample data known as training data—in the context of this invention: images—and the ML, without being explicitly programmed, makes decisions or predictions on new data (new images).

Deep learning (DL) is a branch of ML; however, any perceived differences between the learning techniques would be known to those skilled in the art.

Generally, ML uses ANNs in which a classification will pass through a series of nodes, the results being derived from mixing those outputs when weighted according to different coefficients. It is the process of repeatedly testing the results against a ‘ground truth’ that allows the machine to ‘learn’ the best set of coefficients to perform the required task, and this is termed ‘training’. As these coefficients are initially unknowns, performance is inevitably going to be sub-optimal whilst the ML learns/trains.

An ML system will, therefore, typically comprise an analysis process which is controlled by coefficients, in which the coefficients are optimised by means of the training. This training generally requires, in the case of image processing (as in the present invention), a large set of classified images, allowing the machine to optimise the coefficients used to develop the algorithms and, thereby, ‘learn’. Currently, a set of images is often classified manually by teams of operators reviewing them one-by-one and identifying relevant features. This is, obviously, very labour-intensive and subjective as different members of the team may, or may not, identify certain relevant features or interpret what he/she sees differently.

ML, DL and HAA methodologies have associated disadvantages in the inspection and quality control field. Accordingly, the present invention is aimed at an improved inspection and quality control system.

### SUMMARY OF THE INVENTION

According to a first aspect, the present invention provides a method for inspection and quality control for identifying, and automatically rejecting, non-conformant products, the method comprising:
scanning a product to be tested to provide scanning data of the product;
a) analysing the scanning data in a first inspection path comprising a rule-based analysis of the scanning data to determine conformity or non-conformity of the product; and
b) analysing the scanning data in a second inspection path comprising a machine learning analysis of the scanning data to determine conformity or non-conformity of the product;
analysing relative performance of the first inspection path and second inspection path to determine which provides a greater probability of correctly identifying conformity or non-conformity of the product; and controlling automatic rejection of non-conformant products depending upon which inspection path provides the greater probability of correctly identifying a non-conformant product.

Preferably, each inspection path independently controlling automatic rejection of non-conformant products.

Preferably, training a machine learning analysis utilising real-time scanning data and/or analysis of the scanning data from the first inspection path.

Preferably, the first inspection path classifies the scanning data according to conformity or non-conformity and the second inspection path utilises the same classification.

Preferably, analysing relative performance of the first inspection path and second inspection path over a predetermined time period or frequency.

Preferably, the scanning data is image data, for providing an image of the product. Preferably, the scanning data is image data obtained through scanning the product with electromagnetic radiation. Further preferably, the electromagnetic radiation is microwave, terahertz, infra-red, optical, ultra-violet, X-ray, or gamma ray, or combinations thereof.

Preferably, analysing the data in the first and/or second inspection path comprises analysing an image of the product. Most preferably, analysing an X-ray image.

Preferably, controlling automatic rejection depending upon which inspection path has the higher probability of identifying non-conformity over a/the predetermined time period.

Preferably, controlling automatic rejection using both inspection paths when the respective probabilities of identifying non-conformity are within a pre-determined threshold.

Preferably, the invention provides a method for inspection and quality control for identifying, and automatically rejecting, non-conformant products in a production line.

Preferably, the product is a food product. Alternatively, the product could be any manufactured or processed product on a production line, including a food product, medical device, automotive component, etc.

Preferably, a non-conformant product includes one or more of the group comprising:
a contaminant;
a foreign body;
a dimensional error in a component; and/or
any other physical non-conformity.

An exhaustive list of contaminants and foreign bodies has not been included as these would be well-known to those skilled in the art in their respective inspection and quality control fields.

Preferably, the method further comprising sub-dividing the scanning data into a matrix of product segments, and analysing the scanning data in each product segment to determine conformity or non-conformity of the product segment (and, thereby, the product).

Preferably, one or more of the segments are adjacent and/or overlapping.

Preferably, a position of the non-conformity is indicated by a result of the rule-based analysis of the first inspection path.

Preferably, utilising the scanning data, or determined conformity or non-conformity, of each product segment (in the second inspection path) to reduce a period of training of the machine learning analysis.

Preferably, adapting the product to be tested to include one or more abnormalities which will lead to a non-conformant product determination.

Preferably, adapting the product to be tested to include one or more different types of abnormality in one or more different regions of the product.

Preferably, adapting comprises applying a point spread function or similar operator at a certain position within an/the image.

Preferably, abnormality is: a type of image artefact that represents or simulates a contaminant or foreign body, its size, shape and/or location on or within the product; and/or a component or feature of the product which is absent when it (normally) should be present.

Preferably, training a machine learning analysis utilising scanning data modified to include a pseudo abnormality intended to provide a non-conformity determination.

Preferably, creating a further inspection path utilising the scanning data, in which the scanning data is modified to provide modified scanning data which comprises a pseudo abnormality intended to provide a non-conformity determination.

Preferably, utilising a rule-based analysis of the modified scanning data, and comparing the conformity or non-conformity determination of that analysis with the machine learning analysis to identify products having a true abnormality.

Preferably, analysing the modified scanning data in a third inspection path comprising a rule based machine learning analysis of the modified scanning data and/or a machine learning analysis of the modified scanning data.

Thereby, preferably training the machine learning analysis to detect abnormalities which are undetectable by the rule-based analysis. For instance, where the contrast associated with the non-conformity cannot unambiguously be determined purely by using the rule-based analysis.

Preferably, the method comprising convolving the scanning data to improve discrimination of the non-conformity when using the machine learning analysis.

Preferably, the method comprising training the machine learning analysis with a sparse or segmented data set created from real or artificially generated defects and, most preferably, selecting and switching between the rule based analysis and the machine learning analysis depending upon which provides optimum performance.

According to a second aspect, the present invention provides an inspection and quality control system for identifying, and automatically rejecting, non-conformant products, the system comprises:
means for scanning a product to be tested, for providing scanning data of the product;
means for analysing said scanning data in a first inspection path capable of conducting a rule-based analysis of said scanning data to determine conformity or non-conformity of the product;
means for analysing said scanning data in a second inspection path capable of conducting a machine learning analysis of the scanning data to determine conformity or non-conformity of the product;
means for analysing relative performance of the first inspection path and second inspection path to determine which provides a greater probability of correctly identifying conformity or non-conformity of the product; and means for controlling automatic rejection of non-conformant products depending upon which inspection path provides the greater probability of correctly identifying a non-conformant product.

Preferably, each means for analysing said scanning data is capable of independently controlling automatic rejection of non-conformant products

Preferably, further comprising means for sub-dividing the scanning data into a matrix of product segments, and analysing the scanning data in each product segment to determine conformity or non-conformity of the product segment.

Preferably, further comprising means for adapting the product to be tested to include one or more abnormalities which will lead to a non-conformant product determination.

Preferably, further comprising means for training a machine learning analysis utilising scanning data modified to include a pseudo abnormality intended to provide a non-conformity determination. Most preferably, the means for training comprises means for modifying an image and a training analyser.

Preferably, the means for analysing relative performance further comprises means for comparing the conformity or non-conformity determination of the rule-based analysis of the modified scanning data with the machine learning analysis to identify products having a true abnormality.

Preferably, the apparatus comprises any one or more means configured to implement one or more method features of the first aspect.

In a third aspect, the present invention provides a system comprising two (or a plurality of) methods of inspection (such as ML and HAA), with the means of training the ML with a sparse or segmented data set created from real or artificially generated defects, and a mechanism for selecting and switching between the two methods, depending on which method provides optimum performance.

Preferably, this aspect includes any one or more of the features of the first and/or second aspect.

Advantageously, HAA analysis of images provides the classification for training the ML/DL analysis, and the image data will be derived from actual images being inspected by the HAA analysis as opposed to a set of stored images captured in the past under (almost certainly) different conditions.

Advantageously, an ML system is continuously acquiring data and can improve its accuracy.

Advantageously, segmentation of an image of the product substantially reduces the period of training, as multiple good and/or reject image segments can be acquired from a single image of the product. Segmentation of the image thereby reduces the number of products needed for training—the exact factor depends upon the number of segments created in the image, and the number of good or reject segments.

Advantageously, if it is difficult to obtain a large reject/defect classification set, one can adapt a good image to simulate a defect, contaminant, etc.

Further advantageously, training of an ML system can be sped-up by utilising scanning data modified, preferably in a further inspection path, to include a pseudo abnormality intended to provide a non-conformity determination.

Advantageously, the invention provides a mechanism for optimising the learning process by permitting adjustment of both the number of images in the training set, as well as the number of epochs or iterations required to establish the required coefficients.

Advantageously, overall performance of the system can be improved by creating a training set comprising image defects that are smaller than HAA analysis can normally be expected to detect.

Further advantageously, use of a further inspection path independently of the first and second inspection paths allows the system to work as normal, whilst separately learning a new product or product specification.

### BRIEF DESCRIPTION OF THE DRAWING FIGURES

The invention will now be disclosed, by way of example only, with reference to the following drawing, in which:

FIG. 1 is a block diagram of a machine learning system incorporating both rule-based analysis and machine learning analysis of images.

### DETAILED DESCRIPTION OF THE INVENTION

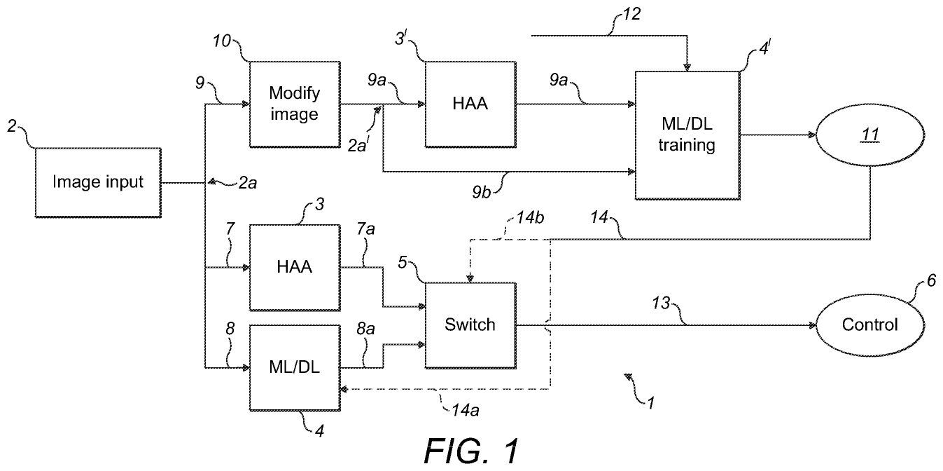

According to a first embodiment, a machine learning (ML) system is identified generally by reference 1 in FIG. 1. The ML system 1 includes an image input 2, a Highly Adaptive Algorithm (HAA) analysis (analyser) 3, machine learning and/or deep learning (ML/DL) analysis (analyser) 4, a performance analyser 5, which includes means capable of switching which analysis controls a controller, and a controller 6.

There are certain applications, such as inspection and quality control of manufactured or processed products, which lend themselves to the use of machine vision or end-of-line X-ray, but these applications are just examples.

Images 2a—scanning data—are supplied to the image input 2 by an X-ray imager (not shown), which is capable of capturing one or a plurality of images of a product moving along a conveyor of a production line. In one version, the image could be captured from a single scan of the product; however, it is more preferred that the image is captured from multiple images of slices of the product, with the multiple images being subsequently combined to form an image of the whole product. As such, the X-ray imager is preferably of the line scan type.

The image input 2 supplies images 2a of the product, which are analysed according to different inspection paths. Analysis of images 2a is conducted in a first inspection path 7, which includes the HAA analysis 3, and in a second inspection path 8, which includes the ML/DL analysis 4. Each of inspection paths 7; 8 provide an input 7a; 8a, respectively, to the performance analyser 5, such that it can evaluate the relative performance of the two image paths 7; 8. The controller 6 receives an input 13 which informs the controller 6 which, if any, products need to be automatically rejected.

In use, both the HAA analysis 3 and the ML/DL analysis 4 are conducted on the same images 2a. Owing to the image processing algorithm underpinning the HAA analysis 3, inspection path 7 can immediately identify, and automatically reject, non-conformant products, i.e. those products that do not meet a required product specification. The HAA analysis 3 identifies non-normality in various aspects of the image 2a, such as distribution of greyscales. The HAA analysis of the images 2a may be used to provide a classified image set required for training the ML/DL analysis 4—although there are other options.

Just by way of example, HAA analysis looks at the ‘normality’ of the image data in several different convolved versions of the image. So, at its simplest, one would expect the grey scale values of the pixels to be broadly represented by a normal distribution. If there are pixels that fall outside of this, they are likely to be contaminants or dense foreign bodies. As an alternative, one could apply a convolution that picks out high-frequency contrast between pixels which are near neighbours (i.e. those pixels that are not necessarily adjacent), and also a convolution that picks out low-frequency contrast between pixels which are close neighbours (i.e. which includes those pixels which are adjacent).

As an alternative, HAA analysis may look at the ‘morphology’ of the image data, which includes considering features of a given shape.

Underlying this is the expectation that ML/DL analysis will, ultimately, provide performance that is superior to the HAA analysis. So the invention is aimed at providing a means of assessing the relative performance of the ML/DL and HAA, and, thereby, calculating a point at which the system should switch between them.

To function correctly, the ML/DL analysis 4 requires training. During a training period, performance of the ML/DL analysis 4 is inevitably going to be sub-optimal. It is clear that an industrial process for inspection and quality control, especially when the product is food, medical devices, pharmaceuticals, etc., cannot tolerate any absence of effective inspection and, whilst the ML/DL analysis 4 is being trained, the HAA analysis 3 provides a backup. Further, if characteristics of the product change over time, the ML/DL analysis 4 may require a period of re-training, during which HAA analysis 3 again takes over. The ML/DL analysis 4 may be trained using a manually created classified image set, or is preferably trained in this embodiment using a classified image set from the HAA analysis 3, which has already determined which images show conformant/non-conformant products. For the ML/DL analysis 4 to be trained, it must be shown many images along with a classification for each image. For example, this classification may be ‘contaminated’ or ‘clean’, or ‘cherry pit present’ or ‘no cherry pit’. It is the classification that establishes the ground truth.

The images are, thereby, classified to represent ‘good’ and ‘reject’ images, correlating to those products which are good—‘clean’ and/or ‘no cherry pit’—and those which should be rejected—‘contaminated’ and/or ‘cherry pit present’-respectively. Where additional difficulties lie is in the requirement of the ML/DL analysis 4 receiving approximately the same number of ‘good’ images, i.e. images of conformant products, as ‘reject’ images, i.e. images of non-conformant products, which can make the training period long and slow. This is addressed in a further embodiment below.

The accuracy of the result of the learning process will be a function of the size of the classification set used for training. Whilst known DL/ML systems may find a 90% success rate acceptable, in the food/medical inspection industries one requires a success rate >99%. One has to have confidence in the inspection detecting, say, a piece of glass in a food matrix, and one would expect the probability of detection to be extremely high.

So, conventional wisdom indicates that a large data set would be required, say ˜100 k images. If one is learning a new product, which could be anything like an image of a ready meal, the system would need to analyse 100,000 packs before the ML/DL analyser is trained and ready to take over. In a production line, that would probably be as little as one day of production. So, by having the ML/DL analysis backed-up by the HAA analysis, the system is still useable while the ML/DL analysis accumulates its data sets.

The performance analyser 5 receives the inputs 7a; 8a from inspection paths 7; 8 and determines which has the greater probability of correctly identifying a non-conformant product. This analysis is used to determine and, thereby, switch which of the HAA analysis 3 or ML/DL analysis 4 independently controls the controller 6 and rejection of products. Accordingly, the performance analyser 5 uses attribute or variable statistical process control analysis to evaluate the correlation between the ground truth and the results of the HAA analysis 3 and the ML/DL analysis 4. In more layman's terms, this could be described as follows—although both are intended to mean the same thing to those skilled in the art. A training purpose for supervised ML requires training images to be associated with a classification, or ground truth. By comparing the statistical distribution of the output results of the members of the input data set, it is possible to establish which of the HAA analysis 3 and the ML/DL analysis 4 produces a higher probability of matching the ground truth. For example, if the result of the ML/DL analysis 4 has a higher probability of matching the ground truth over an extended period than the HAA analysis 3, it would be considered that it is working better. At which point the performance analyser 5 through its switching means would use the ML/DL analysis output as the input 13 to the controller 6 to control whether a product was accepted or rejected. Conversely, if like at start-up, the characteristics of the product or the image generation changed, such that the HAA analysis 3 had a higher probability of matching the ground truth, it would be considered that this method was working better, and the HAA analysis output would be used as the input 13 to the controller 6. This would continue until such a time that the ML/DL analysis had learnt the new characteristics of the product or image generation, to the extent that its performance was considered better.

The analysis of the performance differential—i.e. the point at which the system should switch—may also depend upon the complexity of the system. For instance, the use of multiple images, such as would be encountered in a multispectral system, would clearly provide greater scope for optimisation with ML/DL.

In a follow-on example, in a situation where the image characteristics are relatively uniform or homogenous over a significant area, such as, say, a box of cornflakes, one would expect each segment of the image to reflect the characteristics of the entire image. By applying HAA analysis as a means of classification, a further advantage is provided in that the HAA analysis can identify, not only the existence of a defect (or non-normality), but also where in the overall image that defect is situated. For instance, the image of the box of cornflakes is subdivided into a matrix of 25 segments, arranged as 5×5 regions. One image will therefore provide one segment which is classified as a reject and, at the same time, potentially 24 segments that are classified as good—subject to the defect being in just one segment. This provides a further advantage by substantially reducing the period of training.

As the invention requires learning or training from images, an improved apparatus and method may be provided by using a subset of ANNs known as a CNN (a Convolutional Neural Network). Input data to a CNN is created from image data underlying images 2a and is convolved with a matrix operator, or kernel to extract more relevant data than using raw pixel data.

As will be understood by those skilled in the art, various advantages are provided through just the use of inspections paths 7; 8, however, the following embodiment provides further advantages.

In order to train an ML/DL analysis, we may need, say, 50 k good images (which is readily achievable in a short space of time in a normal production environment), but also 50 k reject images, and this is where lies the problem. It would be extremely difficult to persuade a user to deliberately make bad products to provide the reject images and, so, it may take a great deal of time to train the ML/DL analysis. There are situations where providing reject images is practical, for example cherries that have not passed through the pitting machine may represent the ground truth data for the reject classification, but can be subsequently returned to the production process before the de-pitter. However, in general, when looking for dense foreign bodies, there is no easy way of removing a foreign body from the products. This second embodiment is aimed at that specific problem.

In this second embodiment, a suitably prepared product sample provides a range of defect segments covering multiple types of contaminant or foreign body, or other defect condition. One can create a set of defect images by applying so-called reject features to a good image of a product by manipulating the image with a point spread function corresponding to an expected contaminant. Alternatively, one can modify certain pixels by means of a randomly positioned and randomly scaled and sized adjustment to create a faulty or reject image. This is beneficial where it is difficult to obtain a large defect classification set. In addition, one may use segmentation so as to provide a number of good segments and reject segments, further speeding up training.

A third inspection path 9 is provided in addition to the above-mentioned inspection paths 7; 8, but operates separately to the first and second inspection paths 7; 8. The third inspection path 9 includes an image modifier 10, HAA analysis (analyser) 3′, ML/DL analysis and training (analyser) 4′ and an output 11.

The image modifier 10 (means for modifying) is capable of receiving images 2a and modifying the images to provide an adapted image 2a′ having a simulated defect, contaminant, etc. Adapted images 2a′—modified scanning data—are modified by applying a point spread function or similar operator at a certain position within the image, and those adapted images 2a′ are supplied along inspection paths 9a and 9b to the respective HAA analysis 3′ and ML/DL analysis and training 4′.

The HAA analysis 3′ works in the same way as HAA analysis 3 described above, although it is conducted on adapted images 2a′ not original images 2a from the image input 2, and the HAA analysis 3′ has specific knowledge of where the fault is located. The result of the HAA analysis 3′ is a classification which is used in the ML/DL analysis and training 4′. In this way, one cannot only create training sets autonomously, but also create images that will train the ML/DL analysis to a higher standard than the HAA analysis is normally capable of achieving.

The ML/DL analysis and training 4′ involves use of the classification from the HAA analysis 3′, and the adapted images 2a′ to teach the ML/DL analysis and training 4′ which images have a defect, and where, and which do not, so that, over time, it optimises. Further, the ML/DL analysis and training 4′ may be challenged or trained using an additional input 12. This input 12 may be used to periodically challenge the ML/DL analysis and training 4′, without affecting the images through the original image paths 7; 8. So, one can create reject images without having to eject a product from the production line.

The output 11 includes optimised coefficients which are the result of training the ML/DL analysis and training 4′, through use of the adapted images 2a′ and/or further input or challenge images from input 12. The output 11 provides an input 14 to the ML/DL analysis 4—input 14a—and/or the performance analyser 5—input 14b—and those optimised coefficients are immediately used for determining conformity/non-conformity of a product and/or may be used and improved over time either by learning from the ML/DL 4 directly, or through learning from inspection path 9. One would expect that, once the ML/DL analysis 4 is supplied with the optimised coefficients from input 14a, the probability of it correctly identifying a non-conformant product is improved, but the performance analyser 5 still undertakes the task of deciding which input 7a; 8a should control the controller 6. At the very least, inspection path 9 speeds up training the ML/DL analysis 4.

By way of an alternative, input 14b may either, in addition to 14a or separately from 14a, provide the optimised coefficients directly to performance analyser 5.

Overall performance of the system can be improved by creating a training set comprising image defects that are smaller than HAA analysis can normally be expected to detect.

In this embodiment, training the system takes place using the results of normal production whilst, at the same time, creating a third inspection path in which a pseudo contaminant is incorporated into the image. Of course, images 2a may include images having real contaminants, and these would be identified by HAA analysis 3, and would be separated out from further consideration of adapted images 2a′ in inspection path 9.

In use, images 2a are modified to create adapted images 2a′ which include a pseudo contaminant, and those adapted images 2a′ are supplied to the HAA analysis 3′ by inspection path 9a and to the ML/DL analysis and training 4′ by inspection path 9b. The classification from HAA analysis 3′ is initially used to train the ML/DL analysis and training 4′ whilst production is in operation and, after a period of training, which may include additional input images or challenge images from input 12, inspection path 9 provides output 11, which includes the optimised coefficients required by ML/DL analysis 4. The coefficients are provided as an input 14a to the ML/DL analysis 4, which greatly improves its ability to decide upon conformity/non conformity of products. Ultimately, the performance analyser 5 must still decide upon the respective probabilities of image paths 7; 8, but the optimised coefficients make training the ML/DL analysis 4 quicker. In a preferred embodiment, the optimised coefficients will make the probability of ML/DL analysis correctly determining non-conformity of products greater than that of HAA analysis, such that the switching means acts upon input 7a—through determination 13 and controller 6—to reject a non-conformant product. As a further advantage, inspection path 9a allows the ML system 1 to operate normally whilst inspection path 9b is learning a new product or product specification from input 12, and optimised coefficients are provided at a time they are ready to be used immediately.

Alternatively, or additionally, input 14b provides the optimised coefficients directly to the performance analyser 5.

As described in more detail in the first embodiment, and analogously, use of segmentation during analysis of adapted images 2a′ further speeds up training.

The embodiments of the invention provide a mechanism for optimising the learning process, by permitting adjustment of both the number of images in the training set as well as the number of epochs or iterations required to establish the required coefficients for ML/DL analysis.

The means of establishing the point at which the performance of the ML/DL analysis exceeds (or is sufficiently close to) that of the HAA analysis is based upon a statistical analysis of the two results, and may be challenged at regular intervals to ensure correct operation of the inspection and quality control apparatus and method.

1. A method for inspection and quality control for identifying, and automatically rejecting, non-conformant products, the method comprising:
scanning a product to be tested to provide scanning data of the product;
a) analysing the scanning data in a first inspection path comprising a rule-based analysis of the scanning data to determine conformity or non-conformity of the product; and
b) analysing the scanning data in a second inspection path comprising a machine learning analysis of the scanning data to determine conformity or non-conformity of the product;
analysing relative performance of the first inspection path and second inspection path to determine which provides a greater probability of correctly identifying conformity or non-conformity of the product; and
controlling automatic rejection of non-conformant products depending upon which inspection path provides the greater probability of correctly identifying a non-conformant product.

2. The method as claimed in claim 1 further comprising each inspection path independently controlling automatic rejection of non-conformant products.

3. The method as claimed in claim 1 comprising training the machine learning analysis utilising scanning data modified to include a pseudo abnormality intended to provide a non-conformity determination.

4. The method as claimed in claim 1 comprising creating a further inspection path utilising the scanning data, in which the scanning data is modified to include a pseudo abnormality intended to provide a non-conformity determination.

5. The method as claimed in claim 1, further comprising utilising a rule-based analysis of the scanning data modified to include a pseudo abnormality intended to provide a non-conformity determination, and comparing the conformity or non-conformity determination of that analysis with the machine learning analysis to identify products having a true abnormality.

6. The method as claimed in claim 1, further comprising training the machine learning analysis utilising real-time scanning data and/or analysis of the scanning data from the first inspection path.

7. The method as claimed in claim 1, wherein the first inspection path classifies the scanning data according to conformity or non-conformity and the second inspection path utilises the classification from the first inspection path.

8. The method as claimed in claim 1 comprising analysing relative performance of the first inspection path and second inspection path over a predetermined time period or frequency.

9. The method as claimed in claim 1, wherein the scanning data is image data representing an image of the product.

10. The method as claimed in claim 9, wherein analysing the scanning data in the first and/or second inspection path comprises analysing the image of the product.

11. The method as claimed in claim 1 comprising controlling automatic rejection depending upon which inspection path has the greater probability of identifying non-conformity over a predetermined time period.

12. The method as claimed in claim 1 comprising controlling automatic rejection using both inspection paths when the respective probabilities of identifying non-conformity are within a pre-determined threshold.

13. The method as claimed in claim 1, wherein the method further comprises sub-dividing the scanning data into a matrix of product segments, and analysing the scanning data in each product segment to determine conformity or non-conformity of the product segment.

14. The method as claimed in claim 13, wherein a position of the non-conformity is indicated by a result of the rule-based analysis of the first inspection path.

15. The method as claimed in claim 1, further comprising utilising the scanning data, or a determined conformity or non-conformity, of a product segment to reduce a period of training of the machine learning analysis.

16. The method as claimed in claim 1 comprising:
i) adapting an image of the product to be tested to include one or more abnormalities which will lead to a non-conformant product determination; or
ii) adapting the image of the product to be tested to include one or more different types of abnormality which will lead to a non-conformant product determination in one or more different regions of the product.

17. (canceled)

18. The method as claimed in claim 1, further comprising adapting an image by applying a point spread function or other operator at a certain position within the image.

19. The method as claimed in claim 1 comprising convolving the scanning data to improve discrimination of the non-conformity when using the machine learning analysis.

20. An inspection and quality control system for identifying, and automatically rejecting, non-conformant products, the system comprising:
a scanning apparatus for scanning a product to be tested and thereby providing scanning data of the product;
a first analyser apparatus for analysing said scanning data in a first inspection path configured to conduct a rule-based analysis of said scanning data to determine conformity or non-conformity of said product;
a second analyser apparatus for analysing said scanning data in a second inspection path configured to conduct a machine learning analysis of the scanning data to determine conformity or non-conformity of said product;
a third analyser apparatus for analysing relative performance of the first inspection path and second inspection path to determine which provides a greater probability of correctly identifying conformity or non-conformity of said product; and
a controller apparatus for controlling automatic rejection of non-conformant products depending upon which inspection path provides the greater probability of correctly identifying a non-conformant product.

21. The system as claimed in claim 20, wherein each of the first and second analyser apparatuses for analysing said scanning data is configured to independently control automatic rejection of non-conformant products.

22. The system as claimed in claim 20, further comprising an apparatus for sub-dividing the scanning data into a matrix of product segments, and analysing the scanning data in each product segment to determine conformity or non-conformity of the product segment.

23. The system as claimed in claim 20, further comprising an apparatus for adapting an image of the product to be tested to include one or more abnormalities which will lead to a non-conformant product determination.

24. The system as claimed in claim 20, further comprising an apparatus for training the machine learning analysis utilising scanning data that is modified to include a pseudo abnormality intended to provide a non-conformity determination.

25. The system as claimed in claim 24 wherein the third analyser apparatus for analysing relative performance further comprises an apparatus for comparing the conformity or non-conformity determination of the rule-based analysis of the modified scanning data with the machine learning analysis to identify products having a true abnormality.

26. (canceled)
